(19) United States
(12) Patent Application Publication
(10) Pub. No.: US 2005/0254418 A1
(43) Pub. Date: Nov. 17, 2005

(54) Mobility protocol management apparatus for an IP communication network equipment with a view to continuity of service

(75) Inventors: Jean-Pierre Rombeaut, Maubeuge (FR); Alain Giraud, Igny (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/122,017

(22) Filed: May 5, 2005

(30) Foreign Application Priority Data
May 17, 2004 (FR) 04 50 951

(51) Int. Cl. H04L 12/26

(52) U.S. Cl. 370/219; 370/331

(57) ABSTRACT

An apparatus for managing a mobility protocol for an equipment of an Internet protocol communication network comprises first management means adapted to operate a core of an IP mobility protocol installed in the equipment as a function of current data relating to IP mobility and second management means which are substantially identical to and coupled to the first management means and are adapted to assume an active state, respectively a standby state, when the second management means assume a standby state, respectively an active state. The first and second management means send each other at least some of the current data so that the means in the standby state are substituted for the means in the active state, if required, to operate the mobility protocol core.

### CROSS-REFERENCE TO RELATED APPLICATIONS

This application is based on French Patent Application No. 0450951 filed 17 May 2004, the disclosure of which is hereby incorporated by reference thereto in its entirety, and the priority of which is hereby claimed under 35 U.S.C. §119.

### BACKGROUND OF THE INVENTION

1. Field of the Invention

The invention relates to Internet Protocol (IP) communication networks and more particularly to mobility management within IP networks.

2. Description of the Prior Art

The person skilled in the art knows that an IP network can be considered as a federation of subsets of IP networks (also known as IP subnetworks) interconnected by access equipments forming nodes, such as access routers.

Each communication equipment that connects to an IP network has a native IP address (also know as its home address) that corresponds to the prefix of the native subnetwork (also known as the home subnet) to which it is usually connected. Accordingly, when the equipment is connected to its native subnetwork, the packets of data (also known as datagrams) sent to it are sent directly to its native address by means of a conventional hop by hop routing protocol.

Many communication equipments can be moved and connected to remote or foreign subnetworks (also known as foreign subnets) other than their own native subnetwork, and are known as mobile nodes. This applies in particular to certain mobile or cellular telephones, certain personal digital assistants (PDA), and certain portable computers (also known as laptops). To provide for this kind of connection, a mobile node must have one or more complementary addresses, known as care-of addresses, which it obtains from the IP network, for example by means of a conventional IPv6 mechanism, such as a stateless or stateful autoconfiguration mechanism.

The native address must be associated with each complementary address during a link registration procedure (also known as a binding update) effected between the mobile node and a router of its native network that constitutes its native agent (also known as its home agent).

The change from a mobile node of one subnetwork to another, or even from one IP network to another IP network, i.e. internetwork mobility, is managed by means of a mobility protocol, for example the IP Mobility protocol, so that in particular it is not necessary to reconfigure the mobile node for it to adapt to a remote (sub) network. The mobility protocol uses the results supplied by the routing protocols to forward data packets as if there were no mobility. To be able to manage mobility locally, each mobile node, just like each native agent router, and where applicable each calling network node (also known as a correspondent node) attempting to connect to a mobile node must be equipped with a apparatus for managing the IP mobility protocol.

To enable IP networks to provide continuity of service in the event of maintenance or hardware or software failure of an equipment component (IP router and/or mobile node and/or calling node), it has been proposed to provide at least the IP routers with redundant and/or parallel software and/or hardware capacity. In other words, some routers are equipped with a management apparatus including first and second mobility protocol management means, one of which is in an activated state when the other is in a standby state. In the event of a problem with the activated management means, those means are deactivated and the management means that were previously in the standby state are activated.

However, this operation of changing management means necessitates the transmission to the newly activated management means of all the data relevant to IP mobility, which is not always possible in the event of a software or hardware problem and/or which necessitates a certain time, which may lead to a loss of connection.

The invention therefore has the object of improving on the above situation, and in particular of enabling continuity of service in the presence of high-level (or highly available) mobility, in particular in IPv4 and IPv6 networks, compatible with the current specifications of those IP networks.

### SUMMARY OF THE INVENTION

To this end the invention proposes a apparatus for managing a mobility protocol for an equipment of an Internet protocol communication network, the apparatus comprising first management means adapted to operate a core of an IP mobility protocol installed in the equipment as a function of current data relating to IP mobility and second management means which are substantially identical to and coupled to the first management means, these first management means being adapted to assume an active state, respectively a standby state, when the second management means assume a standby state, respectively an active state, and the first and second management means being adapted to send each other at least some of the current data so that the means in the standby state are substituted for the means in the active state, if required, to operate the mobility protocol core.

In the present context the expression “protocol core” means all data and states linked to mobility.

The management apparatus of the invention may have additional complementary features including, separately or in combination:
supervision means adapted to observe the first and second management means in order to place in the active state the other management means previously placed in the standby state in the event of detection of a problem in the operation of the management means in the active state,
its first and second management means are adapted to send each other all the current data; in this case, the management means in the standby state are preferably adapted to request the management means in the active state to send them all the current data,
its management means in the active state are adapted to analyze the validity of current data that has just been modified and to send valid modified current data to the management means in the standby state,
the current data that is sent is included in a group comprising initial and/or updated IP mobility configuration data, mobility protocol core global data structures, data from table(s) of a native agent associated with a mobile node network equipment and with a native subnetwork of the IP network, data of link cache memory elements of the native agent associated with a mobile node network equipment and with a native subnetwork and of a calling node network equipment exchanging data packets with the mobile node, data of cache memory elements of neighbor native agents of a native agent associated with a mobile node network equipment, data constituting information on distant subnetworks of the IP network, and time data representative of timer states,
its first and second management means share substantially identical communication hardware resources.

The invention also proposes an equipment for an IP network equipped with an action apparatus of the type described hereinabove, for example a native agent router associated with a native subnetwork of the IP network, or a mobile node associated with a native agent router, or a calling node.

The invention is particularly, although not exclusively, suitable for managing mobility in IPv4 networks, as defined in particular in Requests For Comments RFC 2002 and RFC 3344 of the IETF (Internet Engineering Task Force), and IPv6 networks, as defined in particular on the following IETF websites http://www.ietf.org/internet-drafts/draft-ietf-mobileip-ipv6-24.txt and http://www.ietf.org/internet-drafts/draft-ietf-mobileip-mipv6-ha-ipsec-06.txt, and by the IETF working groups Mobility for IPv6 and Mobility for IPv4.

Other features and advantages of the invention will become apparent on reading the following detailed description and examining the appended drawings.

### BRIEF DESCRIPTION OF THE DRAWINGS

FIG. 1 is a diagram of one example of a portion of an IP network.

FIG. 2 is a diagram of one embodiment of a management apparatus of the invention installed in a mobile node.

### DETAILED DESCRIPTION OF THE PREFERRED EMBODIMENT

The drawings constitute part of the description of the invention as well as contributing to the definition of the invention, if necessary.

An object of the invention is to provide continuity of service in the presence of IP mobility within Internet Protocol (IP) communication networks, and in particular in IPv4 and IPv6 networks.

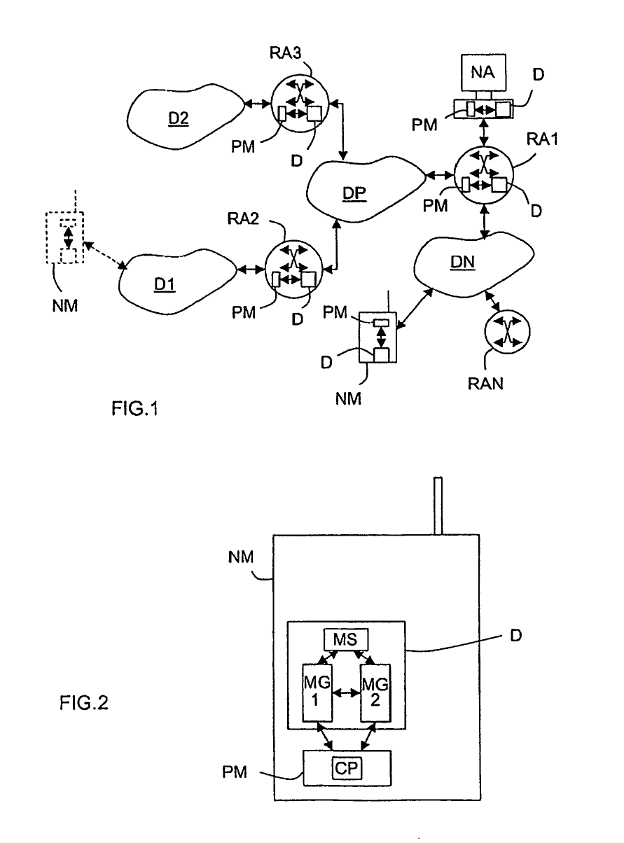

As shown diagrammatically in FIG. 1, an IP network may be considered as a federation of subsets of IP networks DP, DN, D1, D2 (also known as IP subnetworks).

In the present example, the subnetwork DP constitutes, so to speak, a main subnetwork of the IP network to which the other subnetworks DN, D1 and D2 are connected.

The subnetwork DN constitutes the native subnetwork (also known as the home subnet) of at least one host mobile communication equipment NM, also known as a mobile node, for example a mobile or cellular telephone, a personal digital assistant (PDA), a portable computer (also known as a laptop) or a router.

In the present context, the expression “native subnetwork” means the subnetwork to which a mobile node NM is usually connected, i.e. the subnetwork on which it has a native IP address that corresponds to its prefix (also known as its home address).

Each mobile node NM is associated with an access router RAN of its native subnetwork DN, which constitutes its native agent (also known as its home agent). Thus the native IP address of the mobile node NM is registered with the access router RAN. The access router RAN generally stores all position (and location) information for the mobile node NM that is associated with it, i.e. the mobility data that relate to it, and serves as a place of transit for datagrams that must be sent to it when it is connected to an IP subnetwork D1 or D2, referred to as a distant subnetwork (also known as a foreign subnet) other than its native subnetwork DN (also known as its home address).

FIG. 1 also shows a calling node communication equipment NA (also known as a correspondent node) representing a node connected to the native subnetwork DN and wishing to transmit data packets (also known as datagrams) to the mobile node NM, whether it is connected to said native subnetwork DN or to a distant subnetwork D1 or D2 (also known as a foreign subnetwork).

As shown diagrammatically in FIG. 2, to ensure mobility in the sense defined in the introduction, the access routers RAN, the mobile nodes NM and the calling nodes NA are provided with a mobility protocol PM, for example the IPv4 Mobility protocol and the IPv6 Mobility protocol, which use results supplied by the routing protocols of the network. The mobility protocol PM enables a mobile node NM to connect the IP network via its distant networks D1, D2. In particular, it enables a mobile node NM connected to a distant subnetwork, for example the subnetwork D1, as shown in dashed line in FIG. 1, to obtain from the IP network, for example by means of a conventional IPv6 mechanism, such as a stateless or stateful autoconfiguration mechanism, one or more complementary IP addresses (also known as a care-of addresses). The complementary IP address is a unicast routing address. A mobile node NM can have a plurality of complementary IP addresses if it is liable to connect to a plurality of distant subnetworks D1, D2 having different prefixes.

When a mobile node NM is actually connected to one of the distant subnetworks, for example the subnetwork D1, it must advise its native agent RAN for it to register the complementary IP address that has been assigned to it by the distant subnetwork D1. That address is then called the main complementary IP address. A native agent RAN uses this main complementary IP address to send to a mobile node NM that is associated with it the data packets that a calling node NA has sent to it at its native IP address.

The mobility protocol PM enables the mobile node NM to advise its native agent RAN by means of a link procedure (also known as a binding update). The link procedure enables a native agent RAN to associate, within a pair of mobility data items, a native IP address with a main complementary IP address. Accordingly, any packet addressed to the native IP address of a mobile node NM that is temporarily connected to a distant subnetwork D1 is intercepted by its native agent RAN and then transmitted via a tunnel to said mobile node NM at the main complementary IP address that is associated with its native IP address in a stored pair of data items.

To ensure continuity of service in the presence of IP mobility, the invention proposes to equip the access routers RAN and the mobile nodes NM, and preferably the calling nodes NA, with a apparatus D for managing the mobility protocol PM.

To be more precise, as shown in FIG. 2, the management apparatus D comprises substantially identical first and second management modules MG1 and MG2 that are coupled to each other. The first management module MG1 and the second management module MG2 are each capable of operating the core CP of the mobility protocol PM as a function of current data relating to mobility.

In the present context, the expression “protocol core” means all data and states linked to mobility.

The first management module MG1 and the second management module MG2 can either share substantially the same communication hardware resources or use different communication hardware resources.

The implementations of the first management module MG1 and the second management module MG2 vary according to whether they are installed in a native agent AN, a mobile node NM or a calling node NA.

For example, in the case of a native agent AN, each management module MG1, MG2 is first of all responsible for collecting information relating to adjoining native agents within its own native network (for example, in the case of the IPv6 protocol, the cache memory of a neighbor (also known as the neighbor cache)). It is also responsible for knowing all the routers that can provide the native agent function in its native network DN and communicating them to each mobile node NM that is attached to it. It must also manage the reception and processing of binding update messages. Finally, it must serve as a proxy for all packets reaching it that are addressed to the native address of a mobile node NM that is attached to it.

All of the above data is sent to the active management module, but must also be sent to the standby management module (see below).

In the present context, the expression “current data relating to mobility” means data used in the context of IP mobility, i.e. mobility data, timer data, security data and interface configuration data, and more particularly and more precisely:
initial/updated IP mobility configuration data, such as security association data,
global IP mobility engine data structures, such as data relating to interfaces,
home agent table elements, i.e. data from a table or tables of the native agent RAN associated with the mobile node NM and its native subnetwork DN,
data of binding cache elements of the native agent RAN associated with the mobile node NM and of the calling node NA,
data of neighbor cache elements of adjoining native agents of the native agent AN associated with the mobile node NM,
data constituting foreign network information, i.e. information on distant subnetworks D1, D2 of the IP network, such as complementary IP addresses, and
time data representative of states of timers, such as binding update retransmission timer data.

The first management module MG1 and the second management module MG2 may be placed either in an active state or in a standby state. However, when one of the first and second management modules in the active state, the other is in the standby state.

In the present context, the expression “active state” means a state in which the management module MG1 or MG2 receives and sends data. The expression “standby state” means a state in which the management module MG1 or MG2 does not receive data from the outside and is not able to send data (even the timers are not triggered). Note that an intermediate semi-active state may be defined in which the management module MG1 or MG2 receives data but is not able to send data (however, it is able to use the received data internally). In other words, the semi-active state is an active state with no output transmission. It is therefore considered here that the semi-active state is a variant of the standby state in respect of output transmissions.

The management apparatus D preferably includes a supervision module MS coupled to the first management module MG1 and the second management module MG2 in order to observe their operation and in particular the operation of the module that is in the active state. Thus in the event of detection of an operating, software and/or hardware problem in the management module MG1 (or MG2) in the active state, the supervision module MS places said management module MG1 (or MG2) in the standby state and the other management module MG2 (or MG1), up until this point in the standby state, in the active state.

It is important to note that a detected problem does not necessarily relate to the active management module and may equally well relate to the communication hardware resources used by said active management module. A problem may equally relate to the standby management module. In the latter case, the supervision module MS may decide to destroy a process in progress in order to start another.

As soon as a management module MG1 (or MG2) changes from the standby state to the active state, it is immediately substituted for the other management module MG2 (or MG1) in order for the core CP of the mobility protocol PM to operate continuously (i.e. to continue the current process), thereby ensuring the required continuity of service. Note that the management module that was previously active does not change apparatusatically to a standby state. In fact, it no longer exists with regard to the current process, which from this point on is managed by the other management module (it is therefore in the standby state with respect to a current process).

This is because, according to the invention, the first management module MG1 and the second management module MG2 are adapted to send each other at least some of the current data described above.

Two or more current data transmission modes may be envisaged.

In a first mode, the management module in the active state sends the management module in the standby state all the current data described above, either apparatusatically at the initiative of the management module in the active state or at the request of the management module in the standby state.

In a second mode the management module in the active state sends to the management module in the standby state all of the current data described above once, after which it sends only current data that has just been modified.

The first sending (of all the current data) may be effected at the initiative of the management module in the active state or, and preferably, at the request of the management module in the standby state. When the management module in the standby state has received all the current data, it suspends the creation of its communication resources pending receiving a change of state instruction, for example from the supervision module MS.

Subsequent partial transmissions (of only modified current data) may be effected at the request of the management module in the standby state or, and preferably, apparatusatically at the initiative of the management module in the active state.

It is preferable for the management module in the active state to analyze the validity of current data that has just been modified before sending it to the management module in the standby state, so that the latter has at all times valid current data, which is particularly beneficial for ensuring continuity of service if it receives a change of state instruction, for example from the supervision module MS. This type of partial transmission enables incremental updating of the management module in the standby state.

If the management module in the active state is advised that the other management module is in the standby state, it preferably synchronizes it by sending it all the current data relevant to mobility, after which it continues to operate in the conventional way by sending its current data, in full or in part, to the other management module in the standby state.

This achieves continuity of service in the presence of high-level IP mobility, which is therefore compatible with the IP network current specifications.

The management apparatus D of the invention, and in particular its management modules MG1 and MG2 and its supervision module MS, may be implemented in the form of electronic circuits, software (or data processing) modules, or a combination of circuits and software.

The invention is not limited to the embodiments of a management apparatus, mobile node, calling node and access router described above by way of example only, and encompasses all variants that the person skilled in the art might envisage that fall within the scope of the following claims.

1. A apparatus for managing a mobility protocol for an equipment of an Internet protocol communication network, said apparatus comprising first management means adapted to operate a core of an IP mobility protocol installed in said equipment as a function of current data relating to IP mobility and second management means which are substantially identical to and coupled to said first management means, said first management means being adapted to assume an active state, respectively a standby state, when said second management means assume a standby state, respectively an active state, and said first and second management means being adapted to send each other at least some of said current data so that the means in said standby state are substituted for the means in said active state, if required, to operate said mobility protocol core.

2. The apparatus claimed in claim 1 comprising supervision means adapted to observe said first and second management means in order to place in said active state the other management means previously placed in said standby state in the event of detection of a problem in the operation of said management means in the active state.

3. The apparatus claimed in claim 1 wherein said first and second management means are adapted to send each other all said current data.

4. The apparatus claimed in claim 3 wherein said management means in said standby state are adapted to request said management means in said active state to send them all said current data.

5. The apparatus claimed in claim 1 wherein said management means in said active state are adapted to analyze the validity of current data that has just been modified and to send valid modified current data to said management means in said standby state.

6. The apparatus claimed in claim 1 wherein said current data that is sent is included in a group comprising initial and/or updated IP mobility configuration data, mobility protocol core global data structures, data from table(s) of a native agent associated with a mobile node network equipment and with a native subnetwork of said IP network, data of link cache memory elements of the native agent associated with a mobile node network equipment and with a native subnetwork and of a calling node network equipment exchanging data packets with said mobile node, data of cache memory elements of neighbor native agents of a native agent associated with a mobile node network equipment, data constituting information on distant subnetworks of said IP network, and time data representative of timer states.

7. The apparatus claimed in claim 1 wherein said first and second management means share substantially identical communication hardware resources.

8. The apparatus claimed in claim 1 wherein said first and second management means use different communication hardware resources.

9. An equipment for an Internet protocol communication network, comprising a mobility protocol and one or more management apparatus as claimed claim 1.

10. The equipment claimed in claim 9 selected from a group comprising a native agent router associated with a native subnetwork of said IP network, a mobile node associated with a native agent router, and a calling node.
